(19) United States
(12) Patent Application Publication
(10) Pub. No.: US 2026/0238925 A1
(43) Pub. Date: Aug. 13, 2026

(54) SPEAKER

(71) Applicant: FOSTER ELECTRIC COMPANY, LIMITED, Tokyo (JP)

(72) Inventors: Seiichi Ishikura; Kentaro MACHIDA; NAKAJIMA & KATO TAIYO

(21) Appl. No.: 19/148,225

(22) PCT Filed: Jan. 15, 2024
(86) PCT No.: PCT/JP2024/000852

§ 371 Date: Jul. 15, 2025

(30) Foreign Application Priority Data
Jan. 16, 2023 (JP) 2023-004734

(51) Int. Cl. H04R 9/02; H04R 1/06; H04R 9/06

(52) U.S. Cl. CPC H04R 9/025; H04R 1/06; H04R 9/06

(57) ABSTRACT

A speaker having a structure that is suitable for thickness reduction is provided.

A speaker 10 includes a magnetic circuit 40, a first vibrating portion 20, and a second vibrating portion 30. The magnetic circuit 40 includes a first magnet 42, a first magnetic member 41 attached to the first magnet 42, a first yoke 43 attached to the first magnet 42, and a second yoke 45. The first yoke 43 forms a first magnetic gap G 1 between itself and the first magnetic member 41, and forms a second magnetic gap G 2 between itself and the second yoke 45. Further, the second vibrating portion 30 includes a weight 39.

### TECHNICAL FIELD

The present invention relates to a speaker.

### BACKGROUND ART

Patent Document 1 discloses a speaker device for realizing high-quality sound reproduction.

The speaker device includes a first magnetic circuit, a main body portion having a function of emitting sound waves, a second magnetic circuit integrally formed with the first magnetic circuit, and a vibration suppression portion. The main body portion includes a first vibrating portion that is driven by the first magnetic circuit, and the vibration suppression portion includes a second vibrating portion that is driven in a direction opposite to the first vibrating portion by the second magnetic circuit. The second vibrating portion applies vibration that cancels vibration applied to the first magnetic circuit by the first vibrating portion, to the second magnetic circuit.

### PRIOR ART DOCUMENTS

### Patent Documents

Patent Document 1: Japanese Patent Application Laid-Open (JP-A) No. 2006-13587

### SUMMARY OF THE INVENTION

### Problem to be Solved by the Invention

There is room for improvement with regard to thickness reduction of speakers in the above-described technology.

An object of the present disclosure is to provide a speaker having a structure that is suitable for thickness reduction.

### Means for Solving the Problem

A speaker according to a first aspect includes: a magnetic circuit; a first vibrating portion that includes a first bobbin, a first coil, and a first damper; and a second vibrating portion that includes a second bobbin, a second coil, a second damper, and a weight, wherein the magnetic circuit includes a first magnet, a first magnetic member that is attached to the first magnet, a first yoke that is attached to the first magnet and that forms a first magnetic gap between the first yoke and the first magnetic member, and a second yoke that forms a second magnetic gap between the second yoke and the first yoke.

In the present aspect, the speaker includes the magnetic circuit, the first vibrating portion, and the second vibrating portion.

The first vibrating portion includes the first bobbin, the first coil, and the first damper, and the second vibrating portion includes the second bobbin, the second coil, and the second damper.

Further, in the present aspect, the magnetic circuit includes the first magnet, the first magnetic member, the first yoke, and the second yoke. The first yoke forms the first magnetic gap between itself and the first magnetic member, and forms the second magnetic gap between itself and the second yoke.

For this reason, the first yoke can serve as a path for both of magnetic flux passing through the first magnetic gap and magnetic flux passing through the second magnetic gap, and thickness reduction of the magnetic circuit can be achieved.

In this regard, the second vibrating portion includes the weight.

For this reason, compared to an aspect in which the second vibrating portion does not include the weight, an oscillation amount of the second vibrating portion can be reduced while maintaining force that is generated from the second vibrating portion. As a result, thickness reduction of the speaker can be achieved. It should be noted that thickness reduction of the speaker means reducing a size of the speaker in a vibration direction (oscillation direction) of the first vibrating portion, that is to say, reducing an overall height of the speaker.

It should be noted that in the exemplary embodiments, which will be described later, an example is explained in which the second vibrating portion vibrates in order to cancel vibration of the entire speaker due to the first vibrating portion. However, the first vibrating portion and the second vibrating portion of the present aspect are not limited thereto. The second vibrating portion may vibrate in the same direction in synchronization with the first vibrating portion, or may vibrate in another vibration mode for another function.

A speaker according to a second aspect is the speaker of the first aspect, wherein the second bobbin projects out upward with respect to the weight.

In the present aspect, the second bobbin projects out upward with respect to the weight. In other words, the weight does not project out toward the first vibrating portion side, which is upward with respect to the second bobbin.

For this reason, thickness reduction of the speaker is easier to achieve than in an aspect in which, for example, the weight is disposed so as to be hooked at an upper end of the second bobbin.

A speaker according to a third aspect is the speaker according to the first or the second aspect, wherein the second damper includes two elastic bodies, and the weight is disposed between the two elastic bodies.

In the present aspect, the second damper includes two elastic bodies. For this reason, movement symmetry and rectilinearity of the second vibrating portion during oscillation is improved.

Furthermore, the weight is disposed between the two elastic bodies. For this reason, the weight does not adversely affect the thickness reduction of the speaker.

A speaker according to a fourth aspect is the speaker according to any one of the first to the third aspects, wherein the second damper includes a first elastic body and a second elastic body that are disposed so as to overlap with each other in a vibration direction, the first elastic body includes a recessed portion that is recessed in a direction approaching the second elastic body in the vibration direction, and the weight is disposed at a face of the recessed portion at a side opposite from the second elastic body.

In the present aspect, the second damper includes the first elastic body and the second elastic body that are disposed so as to overlap with each other in the vibration direction. Further, the first elastic body includes the recessed portion that is recessed in the direction approaching the second elastic body in the vibration direction, and the weight is disposed at the face of the recessed portion at the side opposite from the second elastic body.

For this reason, there is no need to perform work for arranging the weight between the first elastic body and the second elastic body, and enlargement of a dimension of the second vibrating portion in the oscillation direction can be suppressed.

A speaker according to a fifth aspect is the speaker according to any one of the first to the fourth aspects, wherein the weight has an annular shape that surrounds the second bobbin. The weight is disposed at a spacing in a radial direction from the second bobbin. The weight includes a concave portion that enlarges the spacing between the weight and the second bobbin, at a circumferential direction portion thereof.

In the present aspect, the weight includes the concave portion that enlarges the spacing between the weight and the second bobbin, at the circumferential direction portion thereof.

For this reason, in a case in which soldering or the like is performed at an outer peripheral face of the second bobbin, by providing the concave portion so as to correspond to a location at which the soldering is performed, short-circuiting between the second bobbin and the weight due to solder waste, other metal components, or the like can be suppressed.

A speaker according to a sixth aspect is the speaker according to any one of the first to the fifth aspects, wherein the second damper includes an elastic body that is integrated with a wiring.

In the present aspect, the second damper includes the elastic body that is integrated with the wiring.

For this reason, there is no need to provide an arrangement space for the wiring, thereby facilitating thickness reduction of the speaker.

### BRIEF EXPLANATION OF THE DRAWINGS

FIG. 1 is a cross-sectional view of a speaker according to a first exemplary embodiment.

FIG. 2 is an exploded perspective view of a first vibrating portion.

FIG. 3 is an exploded perspective view of a second vibrating portion.

FIG. 4 is a perspective view of a coupler.

FIG. 5 is a cross-sectional end view of the coupler.

FIG. 6 is a perspective view of a weight.

FIG. 7 is a partial enlarged view of a frame.

FIG. 8 is a cross-sectional view of a speaker according to a second exemplary embodiment.

### EMBODIMENTS FOR IMPLEMENTING THE INVENTION

### First Exemplary Embodiment

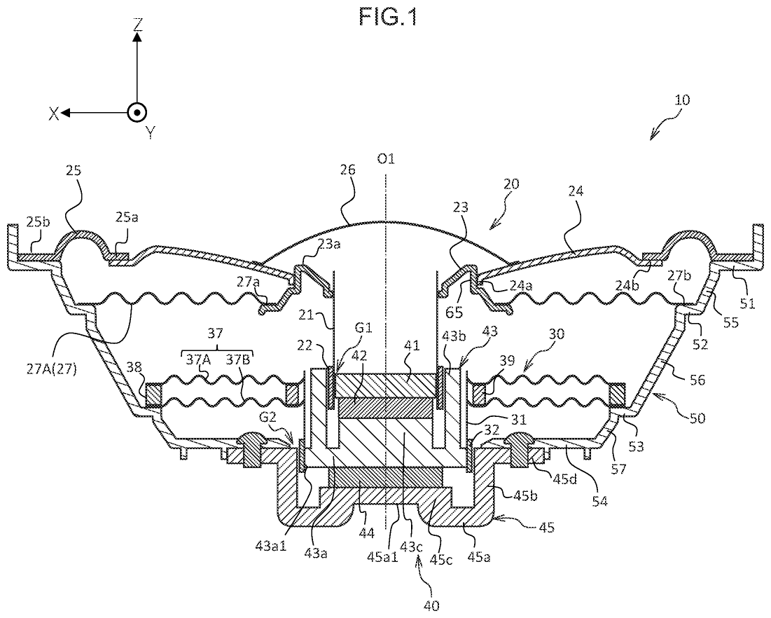

A speaker 10 according to a first exemplary embodiment of the present disclosure will be explained with reference to FIGS. 1 to 7. FIG. 1 is a cross-sectional view taken along an XZ plane passing through a center axis O1 of the speaker 10.

The speaker 10 is installed, for example, at a vehicle door. The speaker 10 is, for example, a woofer or a subwoofer, and is capable of bass sound reproduction at a large input. A main portion of the speaker 10 is axially symmetric with respect to the center axis O1.

The speaker 10 includes a first vibrating portion 20 that vibrates in order to emit sound, a second vibrating portion 30 that vibrates in order to cancel vibration of the entire speaker 10 due the first vibrating portion 20, a magnetic circuit 40, and a frame 50 that supports these.

In the following explanation, a direction parallel to the center axis O1 is referred to as an axial direction, a direction from the second vibrating portion 30 toward the first vibrating portion 20 in the axial direction is referred to as a frontward direction or an upward direction, and a direction from the first vibrating portion 20 toward the second vibrating portion 30 is referred to as a rearward direction or a downward direction. Further, a direction perpendicular to the center axis O1 is referred to as a radial direction.

### (First Vibrating Portion 20)

The first vibrating portion 20 includes a first bobbin 21, a first coil 22, a first damper 27, a diaphragm 24, an edge 25, a cap 26, and a coupler 23.

The first bobbin 21 has a cylindrical shape that is coaxial with the center axis O1. The first coil 22 is formed by being wound around an outer peripheral face of a rear end portion of the first bobbin 21.

The diaphragm 24 is a member that emits sound by vibrating. The diaphragm 24 has a circular hole that is coaxial with the center axis O1 at a center thereof, and has a shape extending toward a radial direction outer side and in a frontward direction from an inner edge portion 24a that forms the circular hole.

The inner edge portion 24a of the diaphragm 24 is joined to the coupler 23.

An outer edge portion 24b of the diaphragm 24 and the frame 50 are connected by the edge 25. An inner edge portion 25a of the edge 25 is joined to a front face of the outer edge portion 24b of the diaphragm 24. The edge 25 is annular in shape, and has a U-shaped cross-section that is convex toward the front. An outer edge portion 27b of the edge 25 is joined to the frame 50.

The first damper 27 supports the first bobbin 21 so as to be capable of vibrating along the center axis O1 direction. The first damper 27 is disposed at a radial direction outer side of the first bobbin 21 and rearward of the diaphragm 24.

The first damper 27 is configured from a single elastic body 27A. The elastic body 27A is an elastic body that has a circular hole that is coaxial with the center axis Ol at a center thereof and that has an annular disc shape extending toward the radial direction outer side from an inner edge portion 27a forming the circular hole, and has a corrugated shape (specifically, a shape that undulates to the front and rear according to a position in a radial direction).

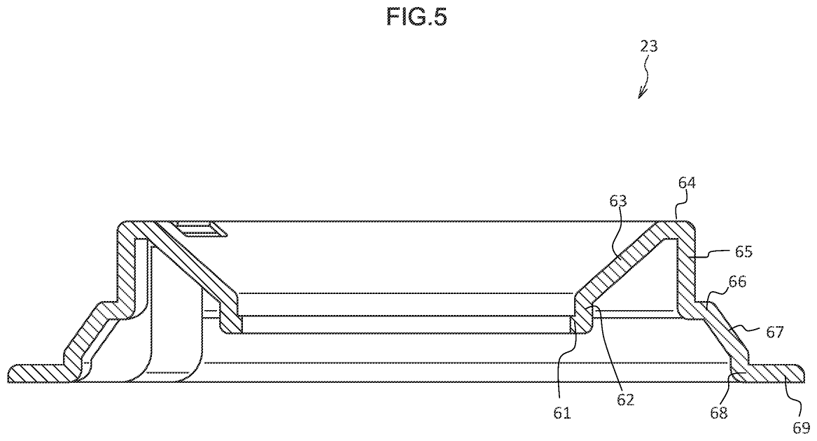

The inner edge portion 27a of the elastic body 27A is joined to a front face of an outer edge portion (fourth horizontal portion 69; refer to FIG. 5) of the coupler 23, and an outer edge portion 27b of the elastic body 27A is joined to the frame 50.

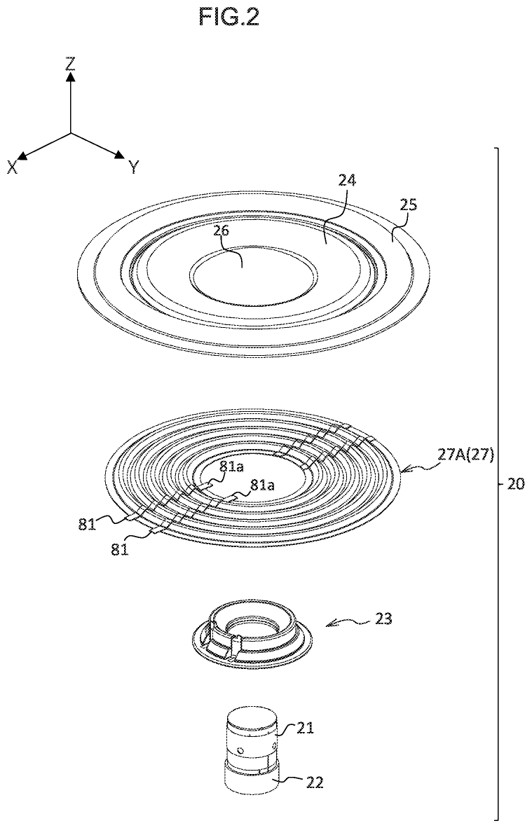

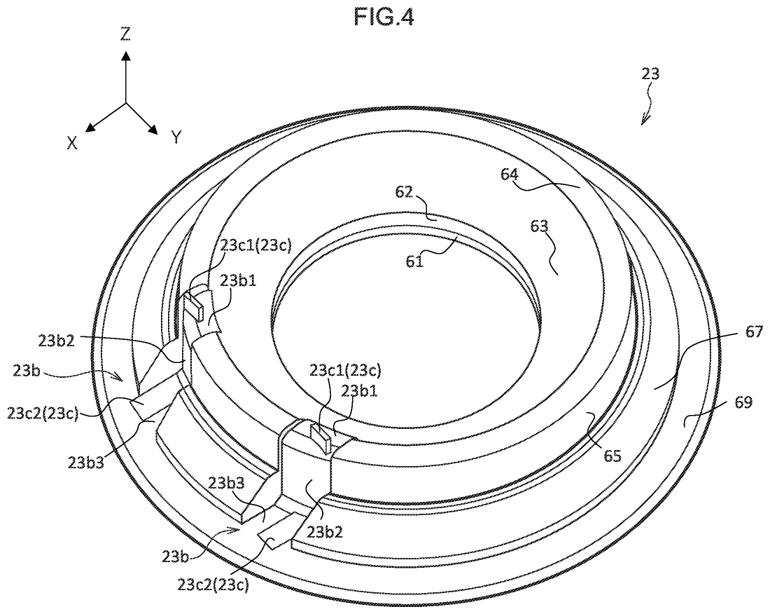

As illustrated in FIG. 2, two belt-shaped wirings 81 (wirings, transmission path) are integrated with the elastic body 27A. Each belt-shaped wiring 81 is provided along the shape of the elastic body 27A at a front face side of the elastic body 27A. That is to say, each belt-shaped wiring 81 has a corrugated shape. The two belt-shaped wirings 81 are disposed at positions that are symmetrical in the Y direction, and each extend in parallel along the X direction. An inner side connection portion 82a of each belt-shaped wiring 82 is connected to a second extending portion 23c2 (refer to FIG. 4) of a relay member 23c, which will be described later.

The cap 26 is a member that emits sound by vibrating. The cap 26 covers the first bobbin 21 and the coupler 23 from the front. An outer edge portion of the cap 26 is joined to a front face of the diaphragm 24.

The coupler 23 is a member that emits sound by vibrating. The coupler 23 is a member that is disposed at an outer peripheral side of the first bobbin 21, and the coupler 23 couples the first bobbin 21 and the diaphragm 24 together, and couples the first bobbin 21 and the first damper 27 together.

As illustrated in FIG. 4, the coupler 23 has a configuration that is basically axially symmetric with respect to the center axis O1.

As illustrated in FIG. 5, the coupler 23 includes, from an inner edge portion toward an outer edge portion, a first horizontal portion 61, a first vertical wall portion 62, a first inclined portion 63, a second horizontal portion 64, a second vertical wall portion 65, a third horizontal portion 66, a second inclined portion 67, a third vertical wall portion 68, and a fourth horizontal portion 69. These configurations have shapes that are axially symmetric with respect to the center axis O1, except for portions at which concave portions 23b, which will be described later, are formed.

The first horizontal portion 61 is a portion extending slightly toward a radial direction inner side from a rear end of the first vertical wall portion 62. The first horizontal portion 61 forms a circular hole that is coaxial with the center axis O1. In a state in which the first bobbin 21 has been inserted into the circular hole, the outer peripheral face of the first bobbin 21 is joined to the first horizontal portion 61 and the first vertical wall portion 62.

The first vertical wall portion 62 has a cylindrical shape. A slight gap in the radial direction is formed between an inner peripheral face of the first vertical wall portion 62 and the outer peripheral face of the first bobbin 21. An adhesive is poured into this gap.

The first inclined portion 63 has a shape that is inclined frontward toward the radial direction outer side. The first inclined portion 63 facilitates an operation of pouring in the adhesive that joins the first bobbin 21 and the coupler 23 together.

The second horizontal portion 64 is a portion extending toward the radial direction outer side from a front end of the first inclined portion 63.

The second vertical wall portion 65 has a cylindrical shape. The inner edge portion 24a of the diaphragm 24 is joined to an outer peripheral face of the second vertical wall portion 65.

An avoidance portion 23a is formed by the first inclined portion 63, the second horizontal portion 64, and the second vertical wall portion 65. The avoidance portion 23a is provided in order to prevent the coupler 23 and a second bobbin 31 from interfering with each other when the speaker 10 is operated. That is to say, the avoidance portion 23a is a portion of the first vibrating portion 20 that is shaped so as to dodge toward the front side in order to prevent interference with the second bobbin 31.

The third horizontal portion 66 is a portion extending slightly toward the radial direction outer side from a rear end of the second vertical wall portion 65. The second inclined portion 67 has a shape that is inclined rearward toward the radial direction outer side. The third vertical wall portion 68 is a portion extending slightly rearward from a rear end of the second inclined portion 67.

The fourth horizontal portion 69 is a portion extending toward the radial direction outer side from a rear end of the third vertical wall portion 68. The fourth horizontal portion 69 configures an outer edge portion of the coupler 23. The elastic body 27A of the first damper 27 is joined to a front face of the fourth horizontal portion 69 by an adhesive or the like.

As illustrated in FIG. 4, the coupler 23 includes two concave portions 23b. The two concave portions 23b are formed at positions that are symmetrical with respect to the Y direction. At the portions at which the concave portions 23b are formed, a front face of the coupler 23 is recessed toward the rear side or the radial direction inner side. Each concave portion 23b is formed in a region extending in the X direction, as viewed from a +Z direction, which is the front side.

Specifically, each concave portion 23b includes a first horizontal face 23b1, a vertical face 23b2, and a second horizontal face 23b3. The first horizontal face 23b1 is a face formed due to the front face of the second horizontal portion 64 being recessed toward the rear, and has a normal direction facing toward the front. The vertical face 23b2 is a face formed due to the second vertical wall portion 65, the third horizontal portion 66, the second inclined portion 67, and the third vertical wall portion 68 being recessed toward the radial direction inner side, and has a normal direction facing toward the radial direction outer side. The second horizontal face 23b3 is a face formed due to the third horizontal portion 66, the second inclined portion 67, and the third vertical wall portion 68 being recessed toward the rear, and has a normal direction facing toward the front. The second horizontal face 23b3 is formed on the same plane as a front face of the fourth horizontal portion 69.

Further, the coupler 23 is formed by insert molding using two relay members 23c as inserts. The two relay members 23c are conductive members, and are disposed at positions corresponding to the two concave portions 23b. The two relay members 23c have the same configuration as each other.

Each relay member 23c is a member obtained by bending an elongated plate member. The relay member 23c includes a first extending portion 23c1 extending in the axial direction, and a second extending portion 23c2 extending in a direction (X direction) that is perpendicular to the axial direction. The plate member configuring the relay member 23c is folded at a right angle at a rear end portion of the first extending portion 23c1, and the second extending portion 23c2 extends in a +X direction from this portion.

A portion at a front end side of the first extending portion 23c1 projects out toward the front side from the first horizontal face 23b1 of the concave portion 23b of the coupler 23, and a wiring (which is not illustrated in the drawings) linked to the first coil 22 is connected to this portion by soldering. Since the portion at the front end side of the first extending portion 23c1 projects out toward the front side from the first horizontal face 23b1 of the concave portion 23b in this manner, a front-rear dimension of the first extending portion 23c1 can be reduced while securing a front-rear dimension of the portion that projects out.

A front face of a portion at a +X direction side of the second extending portion 23c2 is exposed at the second horizontal face 23b3 of the concave portion 23b of the coupler 23 and the front face of the fourth horizontal portion 69, and the inner side connection portion 81a of the belt-shaped wiring 81 integrated with the elastic body 27A of the first damper 27 is joined to this portion by soldering.

### (Second Vibrating Portion 30)

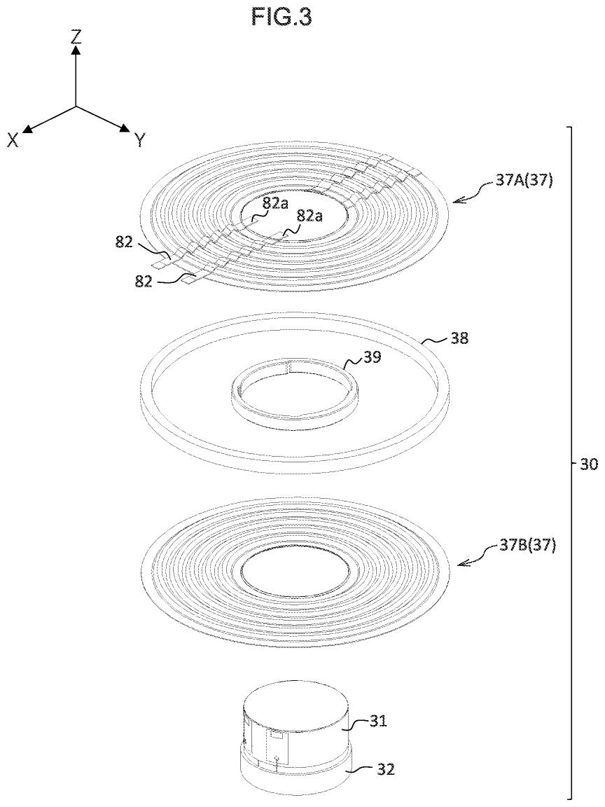

As illustrated in FIGS. 1 and 3, the second vibrating portion 30 includes the second bobbin 31, a second coil 32, a second damper 37, a spacer 38, and a weight 39.

The second bobbin 31 has a cylindrical shape that is coaxial with the center axis O1. The second bobbin 31 has a larger diameter than the first bobbin 21.

The second coil 32 is formed by being wound around an outer peripheral face of a rear end portion of the second bobbin 31.

In the non-operating state illustrated in FIG. 1 (a state in which the speaker 10 is not being operated), a front end of the second bobbin 31 is positioned further toward the front side than a rear end of the first bobbin 21.

The second damper 37 supports the second bobbin 31 so as to be capable of vibrating in the axial direction, with respect to the frame 50.

The second damper 37 includes a first elastic body 37A and a second elastic body 37B that are disposed at a spacing in the axial direction from each other. Each of the first elastic body 37A and the second elastic body 37B has a circular hole that is coaxial with the center axis O1 at a center thereof, is an elastic body having a disc shape extending toward the radial direction outer side from an inner edge portion forming the circular hole, and has a corrugated shape. The first elastic body 37A and the second elastic body 37B each have substantially the same configuration. Thus, when the first elastic body 37A and the second elastic body 37B move in parallel in the axial direction, their cross-sectional shapes overlap with each other.

The spacer 38 for maintaining an axial direction distance between the first elastic body 37A and the second elastic body 37B is provided at an outer edge portion of the second damper 37. A face at a rear side of an outer edge portion of the second elastic body 37B is joined to the frame 50. An inner edge portion of the first elastic body 37A and an inner edge portion of the second elastic body 37B are joined to an outer peripheral face of the second bobbin 31.

Two belt-shaped wirings 82 (wirings, transmission path) are integrated with the first elastic body 37A. Each belt-shaped wiring 82 is provided along the shape of the first elastic body 37A at a front side of the first elastic body 37A. That is to say, each belt-shaped wiring 82 has a corrugated shape.

The two belt-shaped wirings 82 are disposed at positions that are symmetrical with respect to the Y direction, and each extend in parallel along the X direction. An inner side connection portion 82a of each belt-shaped wiring 82 is connected to a transmission path formed at the outer peripheral face of the second bobbin 31.

The weight 39 is provided in order to increase a mass of a portion that is supported and vibrated by the second damper 37. By increasing the mass of the portion that is supported and vibrated by the second damper 37, an oscillation amount of the second vibrating portion 30 can be reduced while maintaining the effect of canceling the vibration of the entire speaker 10 due to the second vibrating portion 30.

The weight 39 is annular in shape, and has an annular shape along the cylindrical shape of the second bobbin 31. The weight 39 is provided in a vicinity of an inner edge portion of the second damper 37. Specifically, it is disposed between the first elastic body 37A and the second elastic body 37B in the vicinity of the inner edge portion of the second damper 37. Thus, the weight 39 is disposed so as to surround the second bobbin 31.

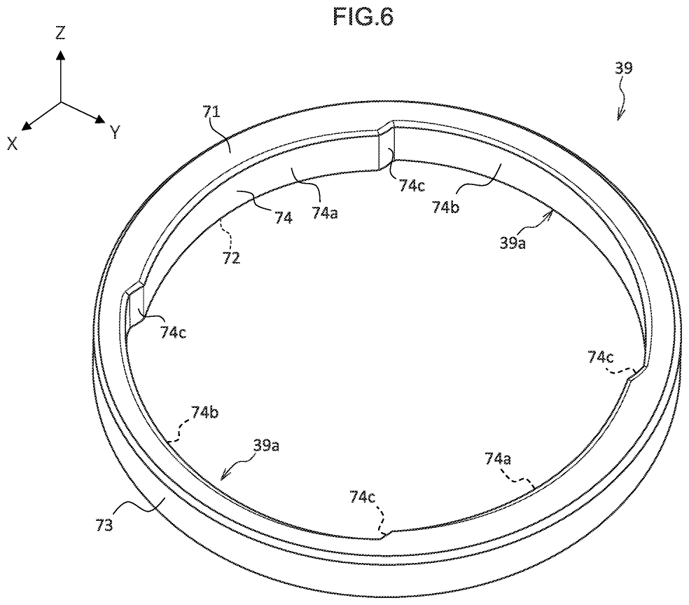

FIG. 6 is an enlarged perspective view of the weight 39. The weight 39 has two concave portions 39a. Due to the weight 39 including the concave portions 39a, a spacing between an inner peripheral face of the weight 39 and the outer peripheral face of the second bobbin 31 is enlarged at portions in a circumferential direction at which the concave portions 39a are formed. The two concave portions 39a are formed at positions facing each other with the center axis O1 therebetween. One of the two concave portions 39a is formed in a range including positions at which the inner side connection portions 82a of the two belt-shaped wirings 82 described above are connected to the transmission path formed at the outer peripheral face of the second bobbin 31.

Specifically, the weight 39 includes a front face 71, a rear face 72, an outer peripheral face 73, and an inner peripheral face 74. The front face 71 is a flat face that has a normal direction facing toward the front, and the rear face 72 is a flat face having a normal direction facing toward the rear. The outer peripheral face 73 is a curved face having a normal direction facing toward the radial direction outer side, and is formed on a single circumference centered on the center axis O1 when viewed from the axial direction. The inner peripheral face 74 includes first inner peripheral faces 74a corresponding to circumferential direction positions at which the concave portions 39a are not formed, and second inner peripheral faces 74b corresponding to circumferential direction positions at which the concave portions 39a are formed. Two first inner peripheral faces 74a are formed, and two second inner peripheral faces 74b are formed. The first inner peripheral faces 74a and the second inner peripheral faces 74b are both curved faces having normal directions facing toward the radial direction inner side, and are formed on an arcs centered on the center axis O1 when viewed from the axial direction.

Further, the weight 39 has connection faces 74c that connect the first inner peripheral faces 74a and the second inner peripheral faces 74b. Two connection faces 74c are formed with respect to one second inner peripheral face 74b. These two connection faces 74c face in a direction (Y direction) in which they face each other. In other words, these two connection faces 74c are parallel to each other.

### (Magnetic Circuit 40)

As illustrated in FIG. 1, the magnetic circuit 40 includes a first magnetic member 41 (a top plate), a first magnet 42, an intermediate magnetic member 43 (a first yoke), a second magnet 44, and a second magnetic member 45 (a second yoke). The magnetic circuit 40 is formed by coaxially stacking the second magnet 44, the intermediate magnetic member 43, the first magnet 42, and the first magnetic member 41 in this order from the second magnetic member 45, which is disposed at the rearmost side.

By providing a configuration in which magnetic circuits corresponding to the first vibrating portion 20 and the second vibrating portion 30 are configured by the single magnetic circuit 40, and in which the magnetic circuit 40 is stacked up from the rear in this manner, assembly performance in a manufacturing process can be improved.

The second magnetic member 45 includes a disc-shaped bottom portion 45a, a cylindrical portion 45b that is erected toward the front from an outer edge portion of the bottom portion 45a, a columnar convex portion 45c that projects out toward the front from a center portion of the bottom portion 45a, and an attachment flange 45d that extends toward a radial direction outer side from a front end of the cylindrical portion 45b. The attachment flange 45d is attached to the frame 50. A recess 45a1 is provided at a rear face of the bottom portion 45a.

The second magnet 44 is joined to a front face of the convex portion 45c. The second magnet 44 has a columnar shape. A diameter of the second magnet 44 is greater than the diameter of the first magnet 42.

The intermediate magnetic member 43 is joined to a front face of the second magnet 44. The intermediate magnetic member 43 includes a disc-shaped bottom portion 43a, a cylindrical portion 43b that is erected toward the front from a peripheral edge of the bottom portion 43a, and a columnar convex portion 43c that projects out toward the front from a center portion of the bottom portion 43a.

The first magnet 42 is joined to a front face of the convex portion 43c. The first magnet 42 has a columnar shape. A diameter of the first magnet 42 is approximately the same as a diameter of the convex portion 43c.

The first magnetic member 41 is joined to a front face of the first magnet 42. The first magnetic member 41 has a columnar shape. A diameter of the first magnetic member 41 is slightly larger than the diameter of the first magnet 42.

A diameter of the bottom portion 43a of the intermediate magnetic member 43 is larger than a diameter of the cylindrical portion 43b. Thus, an outer peripheral portion 43a1 of the bottom portion 43a projects out further toward the radial direction outer side than an outer peripheral face of the cylindrical portion 43b. The outer peripheral portion 43a1 of the bottom portion 43a is referred to as an outer side projecting portion 43a1.

Meanwhile, the front end of the cylindrical portion 45b of the second magnetic member 45 substantially matches a position in the front-rear direction of a front face of the bottom portion 43a of the intermediate magnetic member 43.

Thus, the outer side projecting portion 43a1 faces a front end portion of the cylindrical portion 43b of the second magnetic member 45 in the radial direction.

A front end of the cylindrical portion 43b of the intermediate magnetic member 43 is positioned further frontward than a front face of the first magnetic member 41.

An annular gap is formed between an inner peripheral face of the cylindrical portion 43b of the intermediate magnetic member 43 and outer peripheral faces of the first magnetic member 41, the first magnet 42, and the convex portion 43c. Within this gap, a substantially uniform magnetic field is generated in the circumferential direction in a first magnetic gap G1 formed between the outer peripheral face of the first magnetic member 41 and the inner peripheral face of the cylindrical portion 43b.

The bottom portion 43a of the intermediate magnetic member 43, the second magnet 44, and the convex portion 45c of the intermediate magnetic member 43 are positioned at an inner side of the cylindrical portion 45b of the intermediate magnetic member 43. An annular gap is formed between an inner peripheral face of the cylindrical portion 45b and outer peripheral faces of the bottom portion 43a, the second magnet 44, and the convex portion 45c. Within this gap, a substantially uniform magnetic field is generated in the circumferential direction in a second magnetic gap G2 formed between the outer peripheral face of the bottom portion 43a (an outer peripheral face of the outer side projecting portion 43a1) and the inner peripheral face of the cylindrical portion 45b.

By adjusting a projection amount of the outer side projecting portion 43a1, a spacing of the second magnetic gap G2 can be narrowed, magnetic flux passing through the second magnetic gap G2 can be increased, and leakage magnetic flux can be reduced.

### (Frame 50)

The frame 50 includes a first support portion 51 that supports an outer edge portion 25b of the edge 25, a second support portion 52 that supports the outer edge portion 27b of the first damper 27, and a third support portion 53 that supports the outer edge portion of the second damper 37.

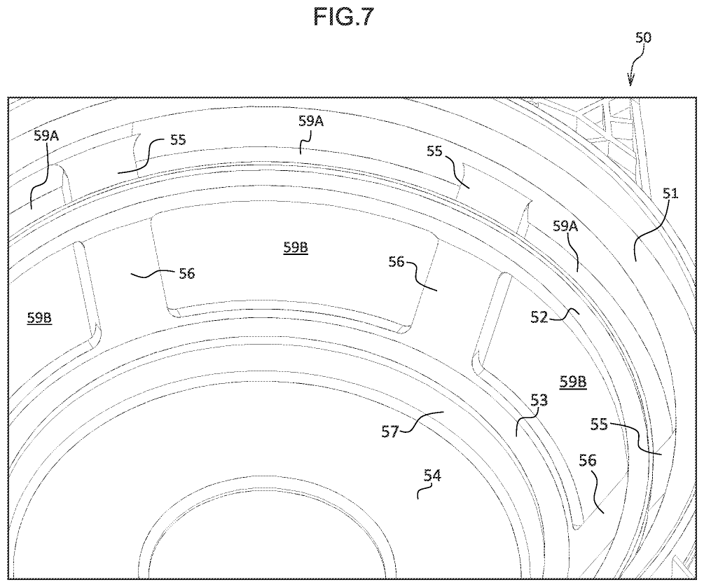

As illustrated in FIG. 7, the first supporting portion 51, the second supporting portion 52, and the third supporting portion 53 are all continuously formed on a circumference centered on the center axis O1. The first supporting portion 51, the second supporting portion 52, and the third supporting portion 53 are joined to the edge 25, the first damper 27, and the second damper 37 at respective faces facing frontward. The first support portion 51 is positioned furthest frontward, and the third support portion 53 is positioned furthest rearward. A diameter of the first support portion 51 is largest, and a diameter of the third support portion 53 is smallest.

The frame 50 includes first coupling portions 55 that couple the first support portion 51 and the second support portion 52 together. As illustrated in FIG. 7, plural first coupling portions 55 are provided separately in the circumferential direction. Thus, plural first openings 59A are formed between the first support portion 51 and the second support portion 52.

The frame 50 includes second coupling portions 56 that couple the second support portion 52 and the third support portion 53. As illustrated in FIG. 7, plural second coupling portions 56 are provided separately in the circumferential direction. Thus, plural second openings 59B are formed between the second support portion 52 and the third support portion 53. Positions in the circumferential direction at which the second coupling portions 56 are provided coincide with the first coupling portions 55.

The frame 50 includes a fourth support portion 54 that supports the magnetic circuit 40. A plate thickness direction of the fourth support portion 54 is along the axial direction. Further, the frame 50 includes a third coupling portion 57 that couples the third support portion 53 and the fourth support portion 54. The third coupling portion 57 is formed continuously in the circumferential direction. Thus, no opening is formed between the third support portion 53 and the fourth support portion 54.

Next, relationships between the magnetic circuit 40, the first vibrating portion 20, and the second vibrating portion 30 will be explained.

The first coil 22 is disposed in the first magnetic gap G1. The first coil 22 is connected to the transmission path. The first bobbin 21 vibrates together with the first coil 22 due to an electric signal from the transmission path and the action of the magnetic field of the first magnetic gap G1, and as a result, the first vibrating portion 20 vibrates. Consequently, sound is emitted.

When this occurs, a first excitation force is generated at the speaker 10 in response to vibration of the first vibrating portion 20. The first excitation force causes a housing, which is fixed to the speaker 10, to vibrate.

The second coil 32 is disposed in the second magnetic gap G2. The second coil 32 is connected to the same transmission path as the first coil 22, and the second bobbin 31 vibrates together with the second coil 32 due to the electric signal from the transmission path and the action of the magnetic field of the second magnetic gap, as a result of which the second vibrating portion 30 vibrates.

The first vibrating portion 20 and the second vibrating portion 30 are configured so as to operate in opposite phases to each other. Specifically, the second vibrating portion 30 is displaced toward the rear when the first vibrating portion 20 is displaced toward the front, and the second vibrating portion 30 is displaced toward the front when the first vibrating portion 20 is displaced toward the rear. Operation of the first vibrating portion 20 and the second vibrating portion 30 in opposite phases to each other can be realized by adjusting magnetization directions of the respective magnets, the direction in which electric current flows, and winding directions of the coils.

### <Operational Effects>

Next, operational effects of the present exemplary embodiment will be explained.

As illustrated in FIG. 1, in the present exemplary embodiment, the speaker 10 includes the frame 50, the magnetic circuit 40, and the first vibrating portion 20 that vibrates in order to emit sound. The first vibrating portion 20 includes the first bobbin 21, the first coil 22, the first damper 27, and the diaphragm 24. The first coil 22 and the first bobbin 21 are elastically supported by the first damper 27 with respect to the frame 50, and the first coil 22 is driven in cooperation with the magnetic circuit 40, whereby the diaphragm 24 vibrates, and sound is emitted.

Further, in the present exemplary embodiment, the speaker 10 further includes the second vibrating portion 30 that vibrates in order to cancel vibration of the entire speaker 10 due to the first vibrating portion 20. The second vibrating portion 30 includes the second bobbin 31, the second coil 32, and the second damper 37. For this reason, vibration of the first vibrating portion 20 that is transmitted to the frame 50 is canceled. Thus, generation of unnecessary vibration that is transmitted to the frame 50 can be suppressed, and vibration of the speaker 10 is suppressed. As a result, degradation of sound quality due to vibration of the speaker 10 is suppressed.

In this regard, in the conventional art in which the inner edge portion 24a of the diaphragm 24 is directly joined to the first bobbin 21, in order to secure appropriate rigidity of the diaphragm 24 and suppress reverse vibration, a large incline is sometimes provided in a vicinity of the inner edge portion of the diaphragm 24. However, when a large incline is provided in the vicinity of the inner edge portion of the diaphragm 24, a height dimension (a total height, a front-rear dimension) of the diaphragm 24 is increased, and as a result, this is disadvantageous to thickness reduction of the speaker 10.

Thus, in the present exemplary embodiment, the first vibrating portion 20 includes the coupler 23. Further, the inner edge portion 24a of the diaphragm 24 is disposed so as to be spaced apart from the outer peripheral face of the first bobbin 21 at the radial direction outer side, and the inner edge portion 24a of the diaphragm 24 and the first bobbin 21 are coupled by the coupler 23.

That is to say, the vicinity of the inner edge portion of the diaphragm in the aforementioned conventional art is replaced with the coupler 23. For this reason, rigidity of a member configured to include the coupler 23 and the diaphragm 24 can be easily secured, without increasing the height dimension of the diaphragm 24. As a result, thickness reduction of the speaker 10 can be achieved while suppressing reverse vibration of the diaphragm 24.

Further, in the present exemplary embodiment, the coupler 23 includes the avoidance portion 23a that avoids interference with the second bobbin 31. For this reason, the first vibrating portion 20 and the second vibrating portion 30 can be disposed closer together than in an embodiment in which the coupler 23 does not include the avoidance portion 23a. As a result, thickness reduction of the speaker 10 can be achieved.

In particular, in the present exemplary embodiment, although not illustrated in the drawings, in a state in which the first bobbin 21 and the second bobbin 31 are closest to each other in the front-rear direction, the front end of the second bobbin 31 is positioned within the avoidance portion 23a.

Further, in the present exemplary embodiment, the inner edge portion 27a of the first damper 27 is disposed so as to be spaced apart from the outer peripheral face of the first bobbin 21 at the radial direction outer side, and the inner edge portion 27a of the first damper 27 and the first bobbin 21 are coupled by the coupler 23.

That is to say, coupling between the diaphragm 24 and the first bobbin 21, and coupling between the first damper 27 and the first bobbin 21, are realized by the coupler 23. For this reason, thickness reduction of the speaker 10 can be achieved compared to an embodiment in which coupling between the diaphragm 24 and the first bobbin 21, and coupling between the first damper 27 and the first bobbin 21, are separately realized at different positions in the front-rear direction.

Further, in the present exemplary embodiment, the inner edge portion 24a of the diaphragm 24 is positioned further toward the radial direction inner side than the inner edge portion 27a of the first damper 27. For this reason, assembly performance of the first vibrating portion 20 including the coupler 23, the diaphragm 24, and the first damper 27 is excellent.

Further, as illustrated in FIG. 4, in the present exemplary embodiment, the coupler 23 includes the concave portions 23b corresponding to the positions at which the transmission path is arranged. For this reason, arrangement of the transmission path is facilitated.

Further, as illustrated in FIG. 4, in the present exemplary embodiment, the coupler 23 is molded using the conductive relay members 23c as inserts. For this reason, a transmission path linked with the first coil 22 and a transmission path linked with an exterior of the speaker 10 can be relayed by the relay members 23c that are inserted into the coupler 23.

Further, as illustrated in FIG. 1, in the present exemplary embodiment, the first vibrating portion 20 includes the edge 25 that elastically supports the outer edge portion 24b of the diaphragm 24. Furthermore, the outer edge portion 27b of the first damper 27 is positioned further toward the radial direction outer side than the outer edge portion 24b of the diaphragm 24.

For this reason, the first damper 27 is positioned rearward of the outer edge portion 24b of the diaphragm 24, and interference between the outer edge portion 24b of the diaphragm 24 and other members can be suppressed. Thus, a distance between the diaphragm 24 and the first damper 27 in the front-rear direction can be set so as to be small, and thickness reduction of the speaker 10 can be achieved.

Meanwhile, since the first damper 27 and the second damper 37 are displaced in opposite directions, a volume of a space between the first damper 27 and the second damper 37 at an interior of the speaker 10 varies greatly.

Thus, in the present exemplary embodiment, the frame 50 includes the second openings 59B (refer to FIG. 7) that link the space between the first damper 27 and the second damper 37 at the interior of the speaker 10, and a space at the exterior of the speaker 10. For this reason, air in the space between the first damper 27 and the second damper 37 at the interior of the speaker 10 can be allowed to escape.

Further, as illustrated in FIG. 1, in the present exemplary embodiment, the coupler 23 includes the vertical wall portion 65 that is in contact with the inner edge portion 24a of the diaphragm 24. For this reason, the vertical wall portion 65 of the coupler 23 becomes a guide, and the diaphragm 24 can be arranged at a desired position with respect to the coupler 23.

Further, in the present exemplary embodiment, the magnetic circuit 40 includes the first magnet 42, the second magnet 44, the first magnetic member 41 that is attached to the first magnet 42, the second magnetic member 45 that is attached to the second magnet 44, and the intermediate magnetic member 43 that is attached to both of the first magnet 42 and the second magnet 44. The intermediate magnetic member 43 forms the first magnetic gap G1 between itself and the first magnetic member 41, and forms the second magnetic gap G2 between itself and the second magnetic member 45.

For this reason, the intermediate magnetic member 43 can serve as a path for both of the magnetic flux passing through the first magnetic gap G1 and the magnetic flux passing through the second magnetic gap G2, and thickness reduction of the magnetic circuit 40 can be achieved.

Further, in the present exemplary embodiment, the second vibrating portion 30 includes the weight 39. For this reason, the oscillation amount of the second vibrating portion 30 can be reduced while maintaining the effect of canceling vibration of the entire speaker 10, compared to an embodiment in which the second vibrating portion 30 does not include the weight 39. As a result, thickness reduction of the speaker 10 can be achieved.

Further, in the present exemplary embodiment, the second bobbin 31 projects out frontward (upward) with respect to the weight 39. In other words, the weight 39 does not project out frontward with respect to the second bobbin 31. For this reason, thickness reduction of the speaker 10 is easier to achieve than in an embodiment in which, for example, the weight 39 is disposed so as to be hooked at the front end of the second bobbin 31.

Further, in the present exemplary embodiment, the second damper 37 includes the two elastic bodies 37A and 37B. For this reason, movement symmetry and rectilinearity of the second vibrating portion 30 during oscillation is improved. Furthermore, the weight 39 is disposed between the two elastic bodies 37A and 37B. For this reason, the weight 39 does not adversely affect the thickness reduction of the speaker 10.

Further, as illustrated in FIG. 6, in the present exemplary embodiment, the weight 39 includes the concave portions 39a that each enlarge the spacing from the second bobbin 31 at a portion in the circumferential direction. For this reason, in a case in which soldering or the like is performed at the outer peripheral face of the second bobbin 31, by providing the concave portions 39a so as to correspond to a location at which the soldering is performed, short-circuiting between the second bobbin 31 and the weight 39 due to solder waste, other metal components, or the like can be suppressed.

Further, as illustrated in FIG. 3, in the present exemplary embodiment, the second damper 37 includes the first elastic body 37A that is integrated with the transmission path (the belt-shaped wirings 82). For this reason, there is no need to provide an arrangement space for the transmission path, thereby facilitating thickness reduction of the speaker 10.

### Second Exemplary Embodiment

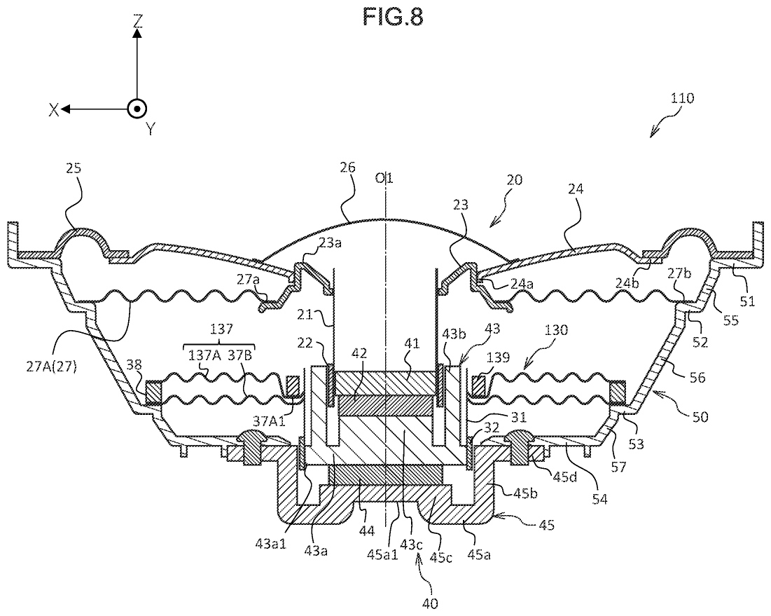

FIG. 8 illustrates a speaker 110 according to a second exemplary embodiment.

In the second exemplary embodiment, a configuration of a second vibrating portion 130 is different from that of the second vibrating portion 30 of the first exemplary embodiment.

The second vibrating portion 130 includes a second damper 137. The second damper 137 includes a first elastic body 137A and a second elastic body 37B that are disposed so as to overlap each other in a vibration direction. Further, the first elastic body 37A includes a recessed portion 37A1 that is recessed in a direction approaching the second elastic body 37B in the vibration direction, and a weight 139 is disposed at a face of the recessed portion 37A1 at a side opposite from the second elastic body 37B. For this reason, there is no need to perform work for arranging the weight 39 between the first elastic body 137A and the second elastic body 37B, and enlargement of a dimension of the second vibrating portion 30 in an oscillation direction can be suppressed.

### <Supplementary Explanation>

Although preferred exemplary embodiments of the present invention have been explained above in detail, the present invention is not limited to the aforementioned exemplary embodiments. Supplementary explanation will be provided below just to be sure.

Materials of respective portions of the first vibrating portion 20 and the second vibrating portions 30 and 130 are not particularly limited. For example, various materials, such as a paper-based materials, resin-based materials, metal-based materials, composite-based materials in which these materials are combined, ceramic-based materials and the like can be used for the diaphragm 24, the first damper 27, the elastic bodies 37A and 37B, and the cap 26. Further, for example, a relatively high-elasticity polymer-based material such as a rubber, a resin or the like can be used for the edge 25. Furthermore, in addition to this, a fiber material may be used as a material of respective portions of the first vibrating portion 20 and the second vibrating portions 30 and 130. Moreover, in respective portions of the first vibrating portion 20 and the second vibrating portions 30 and 130, a rubber coating or the like may be coated on a material serving as a base. A resin-based material, a paper-based material, a metal-based nonmagnetic material or the like can be used for the frame 50 and the spacer 38.

Diameters and thicknesses of respective members illustrated in the respective drawings are merely examples, and there is no limitation to these shapes and dimensions.

In the aforementioned exemplary embodiments, an example in which the coupler 23 is joined to a single elastic body (the elastic body 27A) has been explained, but the present disclosure is not limited thereto. The coupler may be joined to two or more elastic bodies.

Further, in the aforementioned exemplary embodiments, an example in which the diaphragm 24 and the first damper 27 are joined to the coupler 23 has been explained, but other components (for example, a cap) may be further joined to the coupler.

In the aforementioned exemplary embodiments, an example in which the concave portions 23b are formed at positions corresponding to an entirety of the transmission path provided at the coupler 23 has been explained, but the concave portions of the present disclosure are not limited thereto. The concave portions may be formed at at least a portion of positions at which the transmission path is provided.

Further, in a case in which a relay component is provided at the coupler, the coupler does not need to include a concave portion.

In the aforementioned exemplary embodiments, an example in which the coupler 23 is molded using the conductive relay components 23c as inserts has been explained, but the relay components of the present disclosure are not limited thereto. The relay components may be retained at the coupler by a method that is different from insert molding.

Further, the configuration of the weight 39 is also not limited to that of the aforementioned exemplary embodiments.

For example, the weight may be attached to an inner peripheral face side of the bobbin. Further, the weight may be attached to a front end of the bobbin. Furthermore, the shape of the weight is not limited to an annular shape, and may be, for example, a polygonal shape. Further, the weight does not need to include a concave portion. Furthermore, the weight may be in contact with a voice coil in an insulated state.

Further, the configuration of the second damper 37 is also not limited to that of the aforementioned exemplary embodiments.

For example, the second damper may have one elastic body, or may have three or more elastic bodies. Further, two elastic bodies may be attached to the frame by providing a step at the frame, without providing the spacer 38.

The disclosure of Japanese Patent Application No. 2023-004734, filed Jan. 16, 2023, is incorporated into the present specification by reference in its entirety.

### EXPLANATION OF REFERENCE SYMBOLS

10: speaker
20: first vibrating portion
21: first bobbin
22: first coil
23: coupler
23a: avoidance portion
23b: concave portion
23c: relay member
24: diaphragm
24a: inner edge portion
24b: outer edge portion
25: edge
27: first damper
27a: inner edge portion
27b: outer edge portion
30: second vibrating portion
31: second bobbin
32: second coil
37: second damper
37A: first elastic body
37B: second elastic body
39: weight
39a: concave portion
40: magnetic circuit
50: frame
59B: second opening (opening)
65: second vertical wall portion (vertical wall portion)
82: belt-shaped wiring (wiring)
110: speaker
130: second vibrating portion
137: second damper
137A: first elastic body
139: weight
G1: first magnetic gap
G2: second magnetic gap
O1: center axis

1. A speaker comprising:
a magnetic circuit;
a first vibrating portion that includes a first bobbin, a first coil, and a first damper; and
a second vibrating portion that includes a second bobbin, a second coil, a second damper, and a weight,
wherein the magnetic circuit includes:
a first magnet,
a first magnetic member that is attached to the first magnet,
a first yoke that is attached to the first magnet, and that forms a first magnetic gap between the first yoke and the first magnetic member, and
a second yoke that forms a second magnetic gap between the second yoke and the first yoke,
wherein the weight is disposed so as to surround the second bobbin, and
wherein the weight includes a concave portion that enlarges a spacing between the weight and the second bobbin, at a circumferential direction portion thereof.

2. The speaker according to claim 1, wherein the second bobbin projects out upward with respect to the weight.

3. The speaker according to claim 1, wherein:
the second damper includes two elastic bodies, and
the weight is disposed between the two elastic bodies.

4. The speaker according to claim 1, wherein:
the second damper includes a first elastic body and a second elastic body that are disposed so as to overlap with each other in a vibration direction,
the first elastic body includes a recessed portion that is recessed in a direction approaching the second elastic body in the vibration direction, and
the weight is disposed at a face of the recessed portion at a side opposite from the second elastic body.

5. The speaker according to claim 1, wherein the weight is attached to the second damper and is not in contact with the second bobbin.

6. The speaker according to claim 1, wherein the second damper includes an elastic body that is integrated with a wiring.
